(19) United States
(12) Patent Application Publication
(10) Pub. No.: US 2025/0028563 A1
(43) Pub. Date: Jan. 23, 2025

(54) Accelerator Architecture For A Transformer Machine Learning Model

(71) Applicant: The Regents of The University of Michigan, Ann Arbor, MI (US)

(72) Inventors: Wei Lu, Ann Arbor, MI (US); Yuting Wu, Sunnyvale, CA (US); Ziyu Wang, Ann Arbor, MI (US)

(73) Assignee: The Regents of The University of Michigan, Ann Arbor, MI (US)

(21) Appl. No.: 18/778,455

(22) Filed: Jul. 19, 2024

Related U.S. Application Data
(60) Provisional application No. 63/528,102, filed on Jul. 21, 2023.

(51) Int. Cl. G06F 9/50; G06F 17/16

(52) U.S. Cl. CPC G06F 9/5027; G06F 17/16

(57) ABSTRACT

An accelerator architecture is presented for a Transformer machine learning model. The accelerator is comprised of: one or more memory devices, each memory device has a random access memory and is configured for processing in memory, where a key matrix, a value matrix, a query weight matrix, a key weight matrix, and a value weight matrix for an attention mechanism of the Transformer machine learning model are stored in the one or more memory devices; and a control device interfaced with each of the one or more memory devices, the control device is used to coordinate the vector matrix multiplication operations performed on the memory devices, perform other arithmetic and logic operations used in attention blocks that are not suited for the memory devices, and coordinate the updates of the key and value matrices in the one or more memory devices.

### CROSS-REFERENCE TO RELATED APPLICATIONS

This application claims the benefit and priority of U.S. Provisional Application No. 63/528,102 filed on Jul. 21, 2023. The entire disclosure of the above application is incorporated herein by reference.

### FIELD

The present disclosure relates to an accelerator architecture for transformer machine learning models.

### BACKGROUND

Attention-based Transformer models have revolutionized natural language processing (NLP) by capturing long-term dependencies in the input data. Transformer machine learning models, including BERT and GPT-3, have demonstrated superior performance in many NLP tasks compared to convolution neural networks (CNNs) or recurrent neural networks (RNNs), and are becoming increasingly popular in industry and academia. ChatGPT, the AI chatbot, has recently set records for the fastest-growing user base, reaching over 100 million active users per month. The extremely large model size, however, hinders the applications of these NLP models on edge devices where resource and computation are limited.

Many memory-based accelerators have been developed that optimize the dataflow to accelerate the compute-intensive CNNs, but they are not suitable for the memory-intensive GPT inference. The computation process in the Transformer models is very different from the convolution operations: (1) the self-attention computation does not use fixed weights, where accelerators based on compute-in-memory (CIM) architectures rely on stationary the weights; (2) the key, value vectors computed based on the input vectors need to be stored for subsequent computation, requiring frequent write into memory; and (3) the opportunity for weight reuse is less for Transformer models. The ratio between the number of operations and parameters of GPT models is about a factor of 2; whereas, the ratio of a typical DNN such as ResNet-18 is over 50 that allows efficient weight reuse. These properties make it difficult to accelerate GPT-type models with CIM since static random-access memory (SRAM) has very limited memory density while high-density on-chip memories such as resistive random access memory (RRAM) typically have limited endurance (10⁴˜10⁶) and high energy consumption during weight programming. Additionally, the efficient vector-matrix multiplication (VMM) operations of CIM can accelerate compute-intensive tasks typically found in DNNs but does not meet the requirements of constant rewrite of the vectors and matrices involved in GPT models.

Seeing opportunities in these memory-bound problems, DRAM vendors including Samsung and SK Hynix have recently announced their DRAM-based process-in-memory (PIM) technologies by adding limited compute capabilities to the DRAM chip. These PIM solutions allow certain operations to be performed directly on the DRAM chip, thus alleviating the DRAM data transfer bandwidth and latency costs. The very high storage capacity of DRAM in turn ensures all model parameters can be stored. However, the DRAM fabrication process, which typically only supports 3 metal layers, mean only simple, low-density logic circuits can be fabricated on chip.

TransPIM, an attention accelerator based on Samsung's PIM with high bandwidth memory (HBM), shows 22×-115× speedup as compared to CPU. However, the ring broadcast dataflow requires a large local buffer (2 kb) per DRAM bank and direct link between two adjacent banks, which will add significant overhead to the existing DRAM chip.

This section provides background information related to the present disclosure which is not necessarily prior art.

### SUMMARY

This section provides a general summary of the disclosure, and is not a comprehensive disclosure of its full scope or all of its features.

An accelerator architecture is presented for a Transformer machine learning model. The accelerator is comprised of: one or more memory devices, each memory device has a random access memory and is configured for processing in memory, where a key matrix, a value matrix, a query weight matrix, a key weight matrix, and a value weight matrix for an attention mechanism of the Transformer machine learning model are stored in the one or more memory devices; and a control device interfaced with each of the one or more memory devices, the control device is used to coordinate the VMM operations performed on the memory devices, perform other arithmetic and logic operations used in attention blocks that are not suited for the memory devices, and coordinate the updates of the key and value matrices in the one or more memory devices.

A scheduler scheme that works with the proposed architecture that maximizes local processing and parallelism, and reduces latency through early execution of certain operations. scheduler

A mapping that works with the proposed architecture that maximizes local data processing and parallelism, minimizes off-chip data movement, and allows expansion to larger models.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a graph showing parameter and computation cost comparison between ResNet-18 and GPT.

FIG. 1B is a graph showing parameter and computation cost breakdown of GPT3-small.

FIGS. 2A-2D illustrate a typical Transformer model.

FIG. 3 is a diagram of an example processing-in-memory architecture with 16 processing units (PUs) for MAC operations in DRAM and a 2 KB GB for temporary data storage.

FIGS. 4A and 4B show DRAM bank organization and DRAM bank operation stages, respectively.

FIG. 5 is a schematic of a proposed accelerator system having six memory devices and a control device.

FIG. 6 is a diagram depicting a mapping scheme for vector-matrix multiplication operations in the accelerator system.

FIG. 7 is a diagram further illustrating the proposed accelerator system.

FIG. 8 is a diagram showing a pipelined Taylor approximation scheme.

FIGS. 9A and 9B show a Newton-Raphson division algorithm and

a Fast inverse square root algorithm, respectively.

FIG. 10 is a diagram depicting a mapping strategy for the key matrix.

FIG. 11 is a computation execution timeline for a single layer in the proposed accelerator architecture.

FIGS. 12A-12D show mapping and dataflow for the following computations: input projection of attention layers; key results write back; value results write back; and FFN layers with partial sums.

FIGS. 13A and 13B are diagrams showing the simulator flowchart and state transition diagrams for the proposed accelerator architecture.

FIG. 14A is a tree structure of the PIM state machines.

FIG. 14B depicts an example implementation for the PIM package class.

FIGS. 15A-15C depict example implementation of three DRAM functions: decode, set_time and state_update.

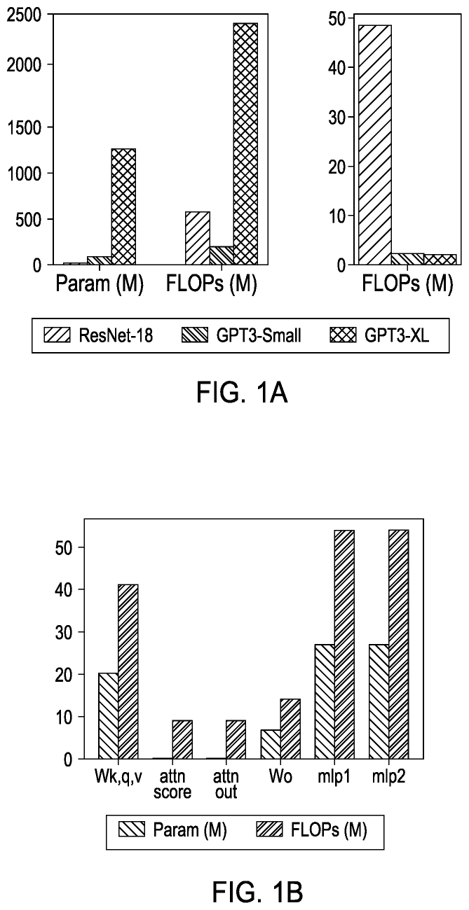

Corresponding reference numerals indicate corresponding parts throughout the several views of the drawings.

### DETAILED DESCRIPTION

Example embodiments will now be described more fully with reference to the accompanying drawings.

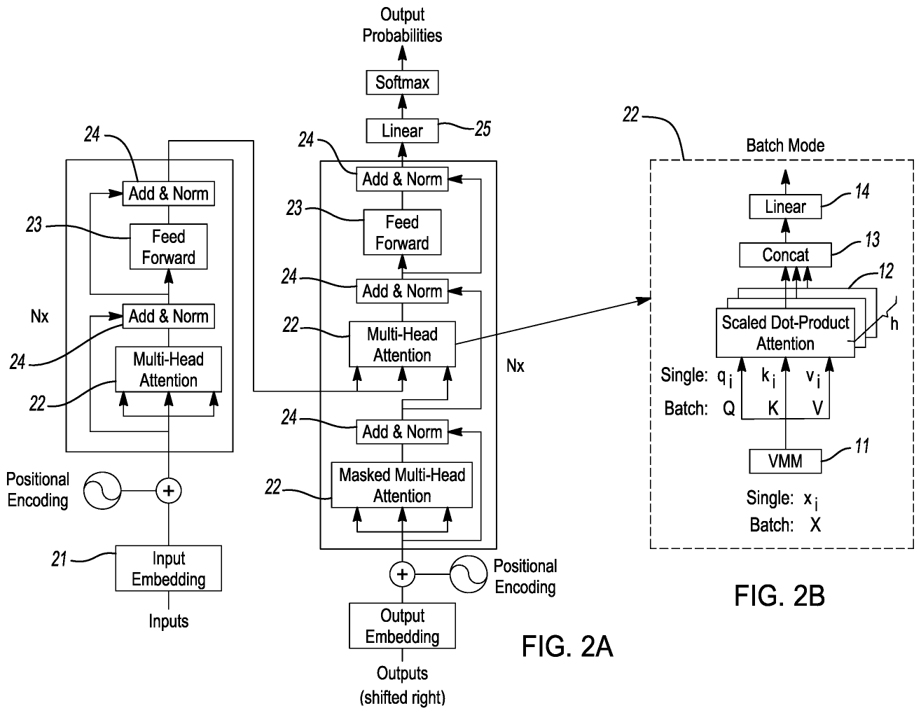

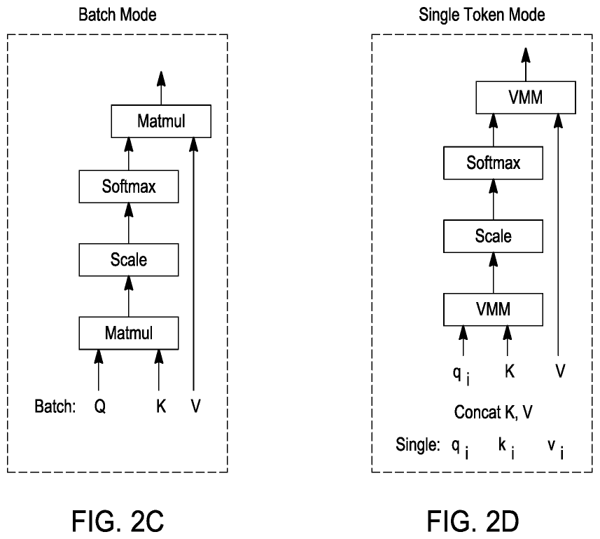

FIGS. 2A-2D illustrate the typical structure of a Transformer machine learning model. Different from CNNs and RNNs, the Transformer model uses a self-attention mechanism that captures the relationship between different words in the whole sentence.

In FIG. 2A, the Transformer model includes an encoder and decoder, both are composed of stacked identical transformer blocks. Each block contains a self-attention module 22 and a feed-forward neural network (FFN) 23. The input content is first parsed into tokens through an input embedding layer 21 and transformed into a sequence of vectors of dimension L×dₘ in a process called input embedding, where L is the token length, and dₘ is the feature dimension of the model. Positional information of each token in the sentence is also added to the input embeddings, and the processed tokens are fed to the Transformer blocks.

In the encoder block, the inputs (sequence of tokens) are first multiplied with three weight matrices (W_{K, Q, V}) to produce corresponding Query (Q), Key (K) and Value (V) matrices, where W_{K} ∈ [symbol] , W_{Q} ∈ [symbol] , W_{V} ∈ [symbol] . The K, Q, V matrices are then passed to the self-attention layer 22 to capture the dependencies between tokens following the following equation:

$$Attention ( Q , K , V ) = soft max ( \frac{Q \cdot {K}^{T}}{\sqrt{{d}_{k}}} ) V \qquad ( 1 )$$

The attention output is the weighted sum of value vectors by the attention score, which is computed by taking the softmax of the scaled dot-product between Q and KT. To allow the model to attend to different aspects from the subparts of the input sentence, the multi-head attention technique is adopted. As shown in FIG. 2B, the input embeddings are transformed into K, Q, V matrices in each attention head in parallel by different learned weight matrices (W_{K}ⁱ,W_{Q}ⁱ,W_{V}ⁱ). Typically, dₖ=dᵥ=dₘ/h is used. Each head independently computes the alignment scores and attention outputs, and then the outputs are concatenated and projected by a linear layer W_{O} ∈ [symbol] to obtain the final attention output.

Followed by the self-attention layer 22, the attention outputs are fed into the feed-forward neural network layer 23, which applies a point-wise feed-forward neural network to each token independently. The feed-forward neural network layer 23 consists of two fully-connected networks: FFN(x)=ReLU(x·Wₘₗₚ₁+bₘₗₚ₁)Wₘₗₚ₂+bₘₗₚ₂, where Wₘₗₚ₁∈ [symbol] and Wₘₗₚ₂∈ [symbol] . The attention and FFN modules are each succeeded by a layer normalization layer 24 and have a residual connection between them, as shown in FIG. 2A. The output from the attention block is then applied as inputs to the next attention block for subsequent processing. An encoder can contain in total N such attention blocks. Afterwards, a final output layer can be trained for a certain task (e.g. classification).

The decoder block has a similar structure as the encoder block, which also includes a linear transformation layer 25, a multi-head self-attention layer 22 and an FFN layer 23 to process the outputs. It introduces a third sublayer, which computes attention based on the query vector from the proceeding decoder block and the K, V matrices from the output of the encoder blocks. A language head can be trained to predict tokens from the decoder output. The new token yᵢ will then serve as the input xᵢ₊₁ to the decoder to generate the next token. The key, value vector kᵢ, vᵢ are concatenated to the K, V matrices computed from the previous inputs.

Unlike the encoder blocks that process all input tokens, the decoder blocks typically handle only one token at a time in the generation task (FIG. 2D). This type of model, including the popular GPT model, falls in the autoregressive model category. Since only one token is processed at a time, the arithmetic intensity is relatively low but the required memory access is high. As a result, PIM techniques are promising for the acceleration of these memory-bounded tasks.

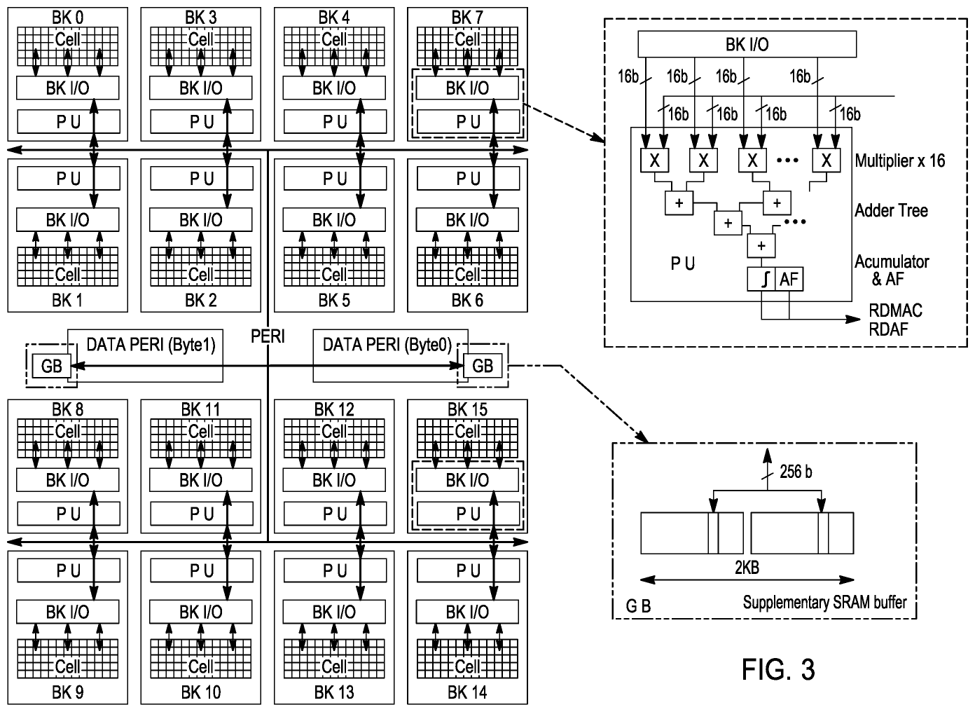

SK Hynix announced its first DRAM-based PIM product sample, called Accelerator-in-Memory (AiM) in 2022. Unlike the PIM design of Samsung that requires high cost high bandwidth memory (HBM), the SK Hynix design is based on standard GDDR6 technology. The computation throughput of one PU achieves 32GFLOPs, about three time of the Samsung design (9.6GFLOPs). FIG. 3 shows the key features and the architecture of AiM. Although reference is made throughout this disclosure to AiM, other process-in-memory devices also fall within the scope of this disclosure.

Each AiM chip consists of two independent channels, and each channel contains 16 DRAM banks with total 4 Gb storage capability and a 2 KB global buffer (GB) for temporary data storage. The data transmission rate is 16 Gb/s/pin, and each GDDR6 channel has 16 pins/channel. Each bank is connected to one processing unit (PU) operated at 1 GHz, which can support MAC operations, element-wise multiplication, bias addition and various activation functions. The MAC command is performed on sixteen 16b weights and sixteen 16b vectors, with each data in brain-float 16b (BF16) format. The weights and vectors can be received from the bank and the GB, respectively. In this mode, 16/4/1 PUs can be activated together. Alternatively, the weights and vectors can be read from an even bank and an odd bank, respectively. In this case, 8/4/1 PUs can perform MAC in parallel. The implementation of the MAC circuit is shown in FIG. 3, which consists of sixteen 16b multipliers, an adder tree and an accumulator. The BF16 format reserves 1 bit for sign, 8 bits for exponent and 7 bits for mantissa to preserve the approximate dynamic range of FP32 precision. The adder tree output is accumulated in the accumulator in FP32 precision. MAC operation is pipelined and can be continuously applied at 1 ns interval until the data within the same row are all consumed. Then the MAC outputs can be non-linearly transformed with the activation function. For simple ReLU and leaky ReLU, the results are directly computed in the internal circuits. For complex activation functions like sigmoid, Tanh and GELU, a lookup table is used.

The AiM design follows JEDEC standards. While some bank groups are performing PU operations, other bank groups can perform the standard read and write operations simultaneously. In summary, the AiM from SK Hynix features true all-bank operations, bank parallelism, seamless interleaving and supports activation function, which makes it attractive for GPT inference accelerations.

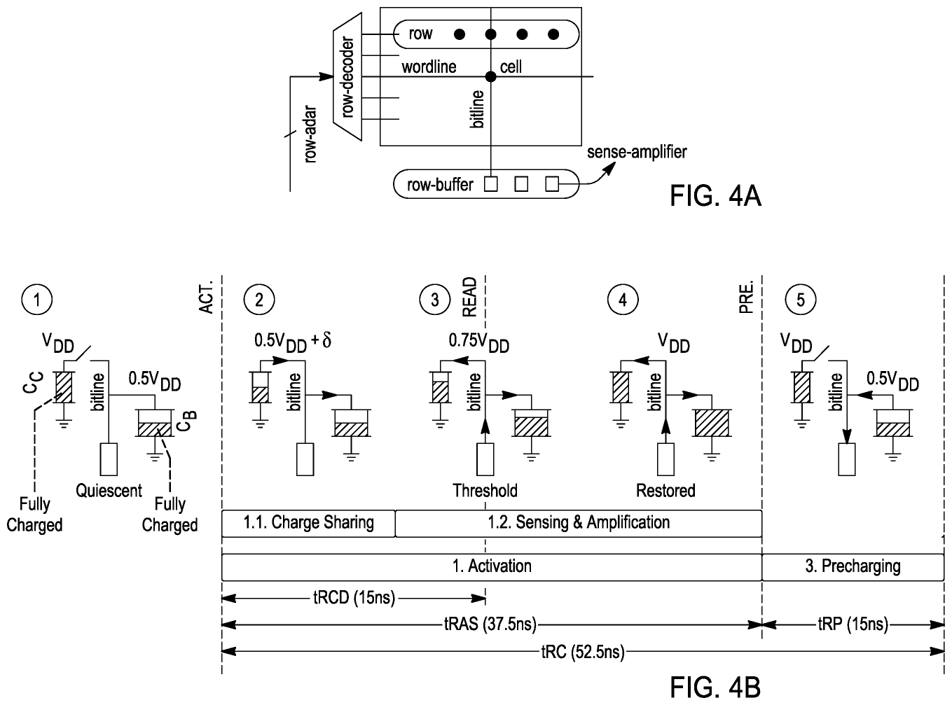

In an example embodiment, the DRAM bank is a two-dimensional array of DRAM cells with a 1T1C structure. The cell represents the binary values of “1” or “0” by the presence or absence of charge. As shown in FIG. 4A, the bit-lines are connected to an array of sense-amplifiers, which is also called row-buffer. The row-buffer stores the data from an entire row read from the DRAM cells.

The operation stages of a DRAM bank for regular read/write operation is illustrated in FIG. 4B. Before a DRAM row is accessed, the bit-lines of the bank are pre-charged (PRE) to

$$\frac{1}{2} {V}_{DD}$$

(state 1). After it receives an activate (ACT) command, the access transistor is turned on, connecting the cell capacitor to the bit-lines. The charge stored in the cell capacitor (CC) is shared with the parasitic capacitor of the bit-line (CB), which causes bit-line voltage to move up (or down) from its original value

$$( \frac{1}{2} {V}_{DD} )$$

in stale 2. Since the reading is disruptive, one needs to restore the information in the subsequent step. After enough time is given for charge sharing, the sense-amplifier is activated to detect the polarity of the perturbation and amplifies the signal. After tRCD latency, sufficient charge has been transferred to the bit-lines (state 3), which cross over the threshold (0.75 VDD or 0.25 VDD). Now the data from the selected row has been retrieved from the DRAM cells to the row-buffer, and the bank is ready for subsequent read/write (RD/WR) operations. For request on an activated row, the minimum (WR-WR or RD-RD) time interval is only t_{CCD}, since the data is already in the row-buffer. Since the access to DRAM is disruptive, one needs to ensure the information in the cell has been restored (0 or VDD) before one can turn off the cell. The time it takes between ACT and PRE is t_{RAS}. If all requests on the same row have been consumed, a PRE command is initiated that disconnects the cell from the bit-lines and return the bank to the quiescent state (state 1) for subsequent access. The time it takes to pre-charge the bit-lines to

$$\frac{1}{2} {V}_{DD}$$

is t_{RP}.

The operations of DRAM cells must fulfill the timing constraints. Premature request initiation or state transition will cause unreliable data access and storage. Table 1 lists the timing constraints of the DRAM-PIM used to model the PIM behavior in the simulator. Since most timing constraints are not available in the GDDR6 standards, one can adopt the GDDR5 timing defined in Ramulator to estimate an upper bound of latency.

TABLE 1
PIM-GPT timing constraints.

| | Commands | | | | | | |
|---|---|---|---|---|---|---|---|
| | ACT→ | PRE→ | MAC→ | WR→ | WR | Refresh | Refresh |
| | R/W | ACT | MAC | WR | Recovery | time | interval |
| | Name | | | | | | |
| | tRCD | tRP | tCCDR | tCCDW | tWR | tRFC | tREFI |
| Value (ns) | 12 | 12 | 1 | 1 | 12 | 455 | 6825 |

Although the abovementioned GDDR6-based AiM design enables VMM acceleration on the DRAM chip, it cannot support the full GPT model standalone. First, storing the whole lookup table of nonlinear functions in all DRAM banks sacrifices DRAM capacity. Decoding MAC results, reading value from corresponding columns to peripheral circuitry and post data processing will add penalty in latency, area and power efficiency. Second, when processing large matrix with long vector multiplication, the vector needs to be split to fit the restricted size of GB. Writing intermediate results back to bank or off-bank latches will result in great power consumption or area overhead, respectively. Third, AiM, amongst other PIM design, cannot support all complex interlayer functions, such as layer normalization, softmax, and residual connection. However, these functions, especially softmax can be a bottleneck when accelerating the large language models.

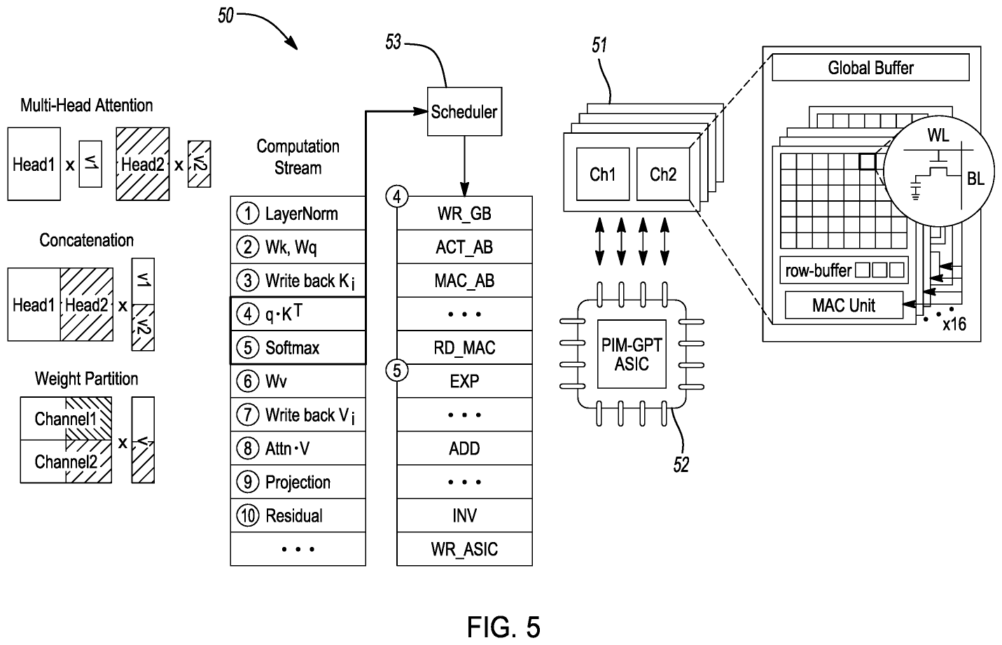

FIG. 5 provides an overview of a proposed accelerator system 50, termed PIM-GPT, which aims to support Transformer-based autoregressive token generation models including GPT. The accelerator system 50 is comprised of one or memory device 51 and a control device 52 (e.g., custom designed ASIC) interfaced with each of the memory devices 51. Each memory device 51 has a random access memory and is configured for processing in memory (PIM). The design principle of the proposed system is to maximally leverage data locality and parallelism to achieve high system performance and energy efficiency during vector-matrix multiplication (VMM) and FFN. To achieve efficient VMM, the accelerator system 50 strategically partitions the model, taking hardware resources into account. It achieves parallel computing by broadcasting a single vector and reducing instruction overhead. The accelerator system 50 employs a specific mapping scheme for the attention mechanism as shown on left side of FIG. 5.

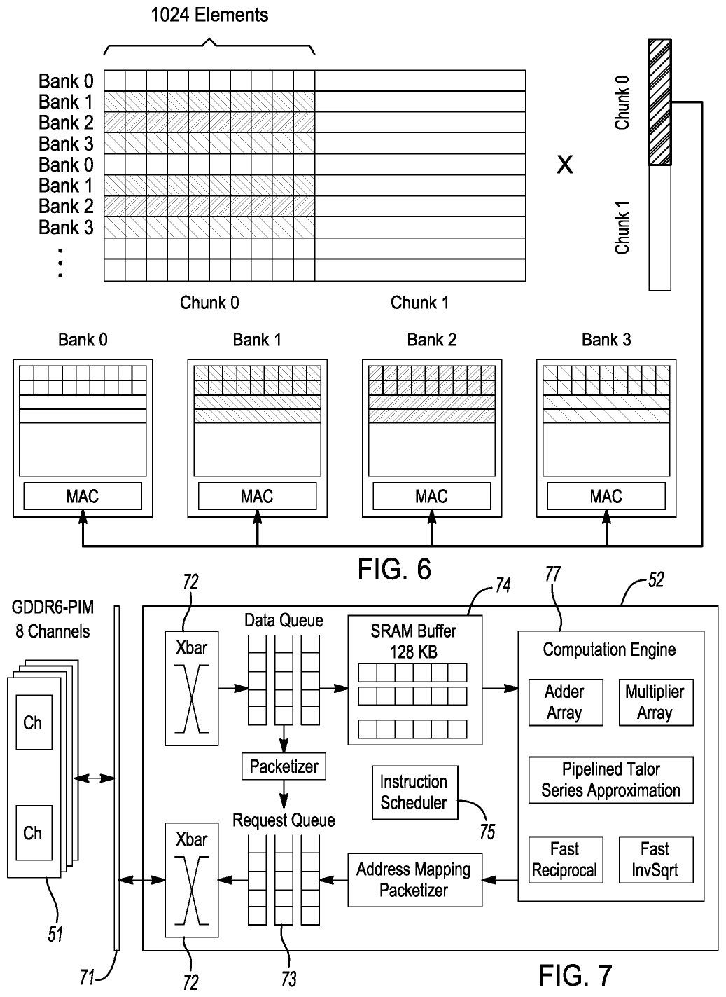

Weight values from multiple attention heads are concatenated to accommodate the physical capacity of DRAM banks. The concatenated attention matrices, along with weights in FFN layers, are distributed to all channels and banks for parallel operation, following the mapping scheme in FIG. 6. The accelerator system 50 utilizes the mature PIM solution with a MAC unit integrated at a bank, which can be easily adapted from the existing LPDDR4 or GDDR6 design, making it a practical solution. The example system integrates 8 channels, each of which executes VMM locally by broadcasting the vector from the buffer and loading matrices from DRAM bank arrays as shown in FIG. 5.

A high-level mapping scheme for VMM operation in the accelerator system 40 is shown in FIG. 6. Since each row of the matrix is multiplied by the same vector, the rows are distributed across all banks. When the VMM begins, the vector is broadcasted to all banks and multiplied with matrix data from each bank in parallel. If the matrix dimension exceeds the physical storage of a bank row, it will be divided into chunks for mapping and computation. Similarly, multi-attention heads are concatenated to a larger matrix to utilize parallel computing capability as well as maximize data locality.

To facilitate end-to-end acceleration of large GPT models, non-VMM functions are executed on the control device 52. It is essential to highlight that the system targets the elimination of off-chip movement of matrix data, requiring only the transfer of input/output vectors between memory devices and the control device for downstream computations, as well as data communication and intermediate data storage. This integration approach leverages the strengths of both the PIM memory devices 51 and the control device 52, optimizing their capabilities to accelerate various computation tasks in the GPT computation stream with minimized data movement between them. The control device 52 (typically implemented as an application-specific integrated circuit, ASIC) includes a data queue, a request queue, an instruction queue, a buffer, a packetizer, a crossbar interconnect, a memory bus, and arithmetic compute engines.

FIG. 5 illustrates the compilation of Attention and Softmax to command streams for the PIM memory devices 51 and the control device 52, respectively. The scheduler 53 operates as a state machine for computation stream compilation. The sequential computation stream of a Transformer decoder is programmed to the registers. Once the previous computation is complete, the scheduler 53 will send the signal and data for the next computation to start. To initiate a task in the computation stream, the scheduler 53 will compile it to a command stream with the model configuration, which is also programmed to the registers of the scheduler. The command stream will run the basic operations of both the memory devices and the control device, as indicated by red and green color in FIG. 5, respectively. In this example, all data in PIM-GPT are in bfloat16 (BF16) format, which preserves the approximate dynamic range of 32-bit floating point numbers to balance performance and accuracy.

FIG. 7 further depicts an example implementation for the proposed accelerator system 50. Eight GDDR6-PIM channels are used to accelerate the expensive VMM operations in the attention and FFN layers to take advantage of parallel processing. The data will only be read from memory when 1) a sub-computation graph is complete and requires downstream computation or communication; and 2) partial results of long vectors are generated and are pending partial sum operation with the subsequent results. Besides reducing off-chip memory access by performing VMM on PIM chips, the two scenarios that still require data read will get data from the PU output registers rather than from the DRAM banks which eliminates expensive row activations commands.

The DRAM channels communicate with the control device 52 through memory bus 71 and crossbar interconnects 72. The interconnect supports data fetching from any channel and sending memory requests to a single channel or broadcast to all channels. The data read from DRAM has two possible paths on the control device 52: 1) writing back to banks in other DRAM channels, such as K, V matrices for subsequent VMM operations; and 2) going through computation blocks in the control device, such as layer normalization, softmax, etc. For data that needs to be written back to DRAM, the control device (ASIC in this example) serves as a data hub which packets data with memory addresses into memory requests. The crossbar interconnect 72 will forward requests from the request queue 73 to the target memory channel. If the data require downstream computation, they will be stored in the on-chip SRAM buffer 74. The controller of the computation engine 77 will fetch data from the SRAM buffer 74 and activate the required computation blocks with given instruction from the instruction queue.

The dataflow of GPT models is fully deterministic. As a result, the PIM-GPT compiler can abstract the computation graph to instruction sequences offline, according to the model configurations as shown in Table 3. The instruction of each sub-computation graph will be stored in the instruction queue 75. Since the same instruction will execute recursively through layers and tokens, the instruction queue 75 is designed as a ring buffer architecture. The pointer to the instructions in the buffer is controlled by the computation data status. At runtime, the instructions are packed with corresponding DRAM or SRAM addresses, followed by decoding instructions into PIM DRAM command sequences.

The proposed accelerator system 50 is designed for full stack autoregressive transformer model acceleration. The computation engines on the control device 52 are responsible for 1) sub-computation graphs that cannot be run in the PIM PU, such as layer normalization and softmax; and 2) sub-computation graphs that cannot be processed efficiently in DRAM, such as partial sum and activation functions. The computation engine 77 composes five computation blocks in this example. All of them operate on data of bfloat16 format to preserve higher precision than fixed point data, which are extensively used in PIM accelerators. In the example implementation, the adder and multiplier arrays include 256 standalone adders and 128 multipliers, which are used for pointwise addition and multiplication. Non-linear functions such as e^{x} and tan h(x) are approximated using Taylor series with first 6 items, which can provide sufficient precision at the given input range. Instead of implementing a divider, the proposed accelerator system 50 exploits light weighted fast iteration algorithms to compute reciprocal and inverse square root. Such designs reuse existing adders and multipliers and offer both latency and area efficiency advantages when compared to a floating-point divider. Details of the computation engine implementation will be discussed below.

The SRAM buffer 74 and computation engine 67 in the control device 52 are designed for billion-parameter level LLM models such as GPT3-XL. For smaller models or instructions that only utilize portions of the computation resources, power gating schemes will be applied to SRAM arrays or unused computation blocks to lower the ASIC power consumption.

The area and power breakdowns of the ASIC design are shown in Table 2. The area and power of the computation components in an example implementation are obtained from the synthesis results from Synopsys Design Compiler at TSMC 28 nm technology node. The ASIC design baseline contains 256 adders and 128 multipliers, 16 pipelined Tayler series approximator, 1 fast reciprocal unit and 1 fast inverse square root unit. The total size of SRAM is 128 KB, which contains 32 of 256×128 SRAM subarrays. Data queue and request queue are implemented at 64-depth to support 16-bit data and 32-bit memory requests.

TABLE 2
Area and power breakdowns of the ASIC design in PIM-GPT.

| Component | Area (mm²) | Power (mW) |
|---|---|---|
| Adder | 0.0304 | 29.70 |
| Multiplier | 0.0275 | 19.06 |
| Taylor Series | 0.0388 | 20.66 |
| Reciprocal | 0.00311 | 1.41 |
| Inverse Square Root | 0.00155 | 0.73 |

The adders and multipliers in the computation engine 77 follow the standard floating-point unit design to support summation and multiplication. For design reuse and performance considerations, other computation tasks are all implemented with approximation algorithms using only addition and multiplication to achieve the required precision.

Three main functions that require approximation-softmax, layer normalization and activation function Gaussian error linear unit (GELU) are described in Equation (2)-(4) below.

$$s ( {x}_{i} ) = \frac{{e}^{{x}_{i}}}{{\sum }_{j = 1}^{N} {e}^{j}} \qquad ( 2 )$$

$$y = \frac{x - E [ x ]}{\sqrt{Var [ x ] + ε}} \times γ + β \qquad ( 3 )$$

$$GELU = \frac{x}{2} \times [ 1 + erf ( \frac{x}{\sqrt{2}} ) ] \qquad ( 4 )$$

To maximize the throughput of the proposed accelerator system 50, the variance value is calculated using Equation (5). GELU is approximated using Equation (6).

$$Var [ x ] = E [ {x}^{2} ] - {( E [ x ] )}^{2} \qquad ( 5 )$$

$$GELU ( x ) = \frac{x}{2} \times [ 1 + tanh ( \sqrt{2 / π} ( x + 0.044715 \times {x}^{3} ) ) ] \qquad ( 6 )$$

The nonlinear function e^{x} in equation (2), tan h(x) in equation (6), division and square root cannot be naively computed using addition and multiplication. Under given precision and data range, they can be efficiently approximated and converge in rapid iterations. Here, e^{x} and tan h(x) are computed using Taylor series approximation, which can be computed with addition and multiplication in several steps, as shown in Equation (7) and (8).

$${e}^{x} = 1 + x + \frac{{x}^{2}}{2 !} + \frac{{x}^{3}}{3 !} + \frac{{x}^{4}}{4 !} + \frac{{x}^{5}}{5 !} + 0 ( {x}^{6} ) \qquad ( 7 )$$

$$tanh ( x ) = x - \frac{{x}^{3}}{3} + \frac{2 {x}^{5}}{15} + 0 ( {x}^{7} ) \qquad ( 8 )$$

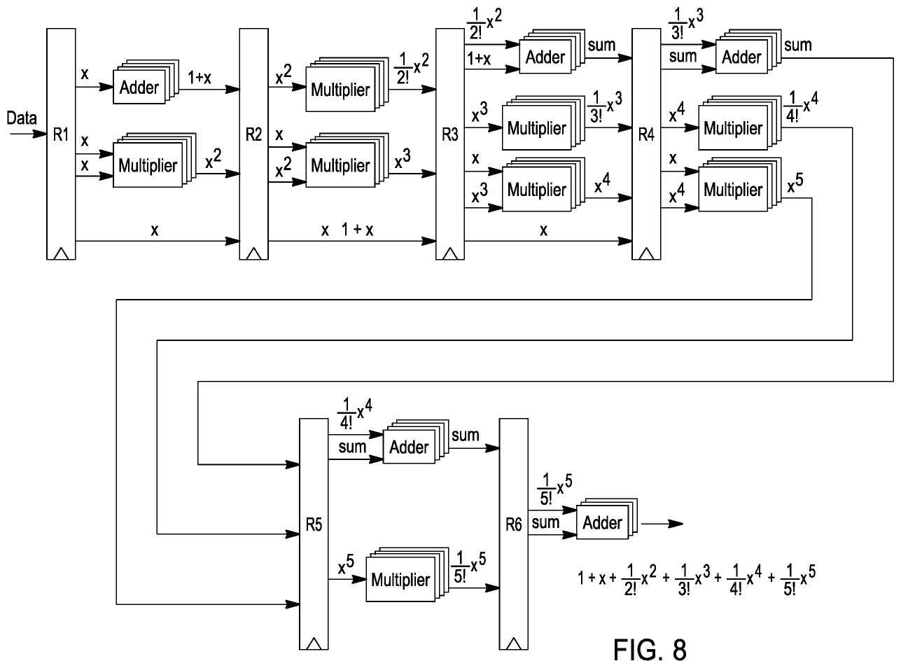

For softmax computation, the exponential value of every element in the vector needs to be calculated. To improve the throughput a pipelined Taylor series approximation block is implemented in the control device 52 as shown in FIG. 8. The first 16 input data from the vector are fed into Taylor series approximation in the first clock cycle. Once the first group of data goes into the second stage, the next 16 input data are fed into the first stage for processing. To compute the first six items in the Taylor series, a 6-stage pipeline is required. This design can be easily extended with higher precision by adding more stages. The tan h(x) function is computed in a similar fashion.

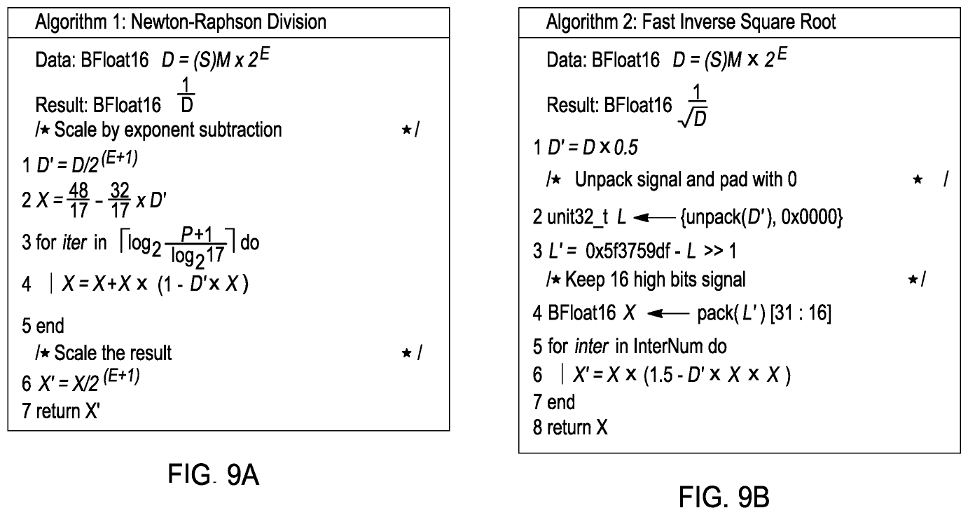

The division operation is computed by multiplying the numerator with the reciprocal of the denominator. Both reciprocal and inverse square root operations can be calculated with addition and multiplication following Newton's method. The key to the convergence of Newton's method is finding a proper initial value to start iteration. The implementation takes advantage of Newton-Raphson division for reciprocal computation and fast inverse square root first implemented in Quake III Arena's source code. The algorithms are summarized in FIGS. 9A and 9B.

In FIG. 9A, the Newton-Raphson Division algorithm is friendly for floating point numbers since it requires the input D to scale to a value close to 0, which can be easily done with exponent subtraction and mantissa shift in floating point data format. The P in line 3 is the precision of P binary places. Hence, for a 16-bit floating point number, it will take three iterations to get an accurate result. The result will be scaled back according to the initial scaling. The fast inverse square root algorithm in FIG. 9B unpacks the bfloat16 data into integer data type, and packs it back afterwards. For unpack, if a float input is [S]0[E]11010100[M]1111000, it will be reformatted into 32-bit float data type by adding 16 0s at the end of the mantissa to get an accurate approximation. It is then converted to a 32-bit integer using floating point data bits directly, i.e the result is 0110_1010_0111_1000_0000_0000_0000_0000 in binary. The constant and algorithm in line 3 is adopted from Quake III Arena's source code. The following pack step utilize the 16 high bits of L′ to assemble a bfloat16 data's sign bit, exponent and mantissa. In the fast square root algorithm, it can converge in a single step iteration. In the example implementation, a conservative two step iteration is taken.

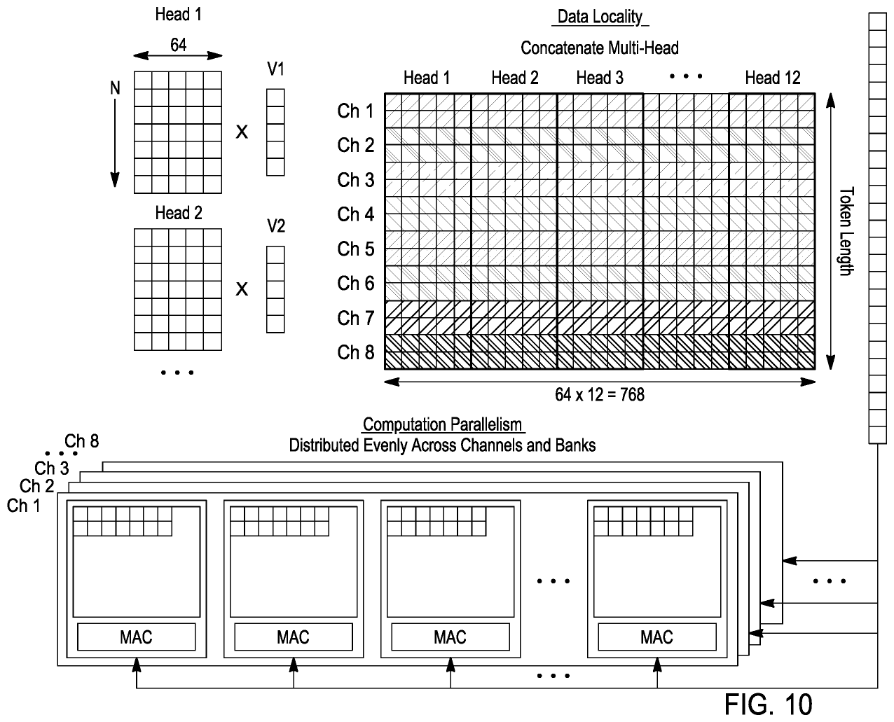

The accelerator system aims to distribute workloads among all memory device and the control device efficiently. For VMM operation, the input vector is forwarded from the control device to the buffer of all memory device channels, followed by broadcasting to all MAC units, as depicted in FIG. 10. All MAC units in the memory devices will execute MAC of the same vector on different matrix partitions in parallel to fully utilize the PIM computation resources without instruction overhead. The accelerator system 50 implements the following techniques to coordinate workload between the PIM memory device 51 and the control device 52: (1) The partial outputs of VMM can be forwarded to the control module before the whole computation is completed, which effectively eliminates the data write back to DRAM banks; (2) when input vector length exceeds the PIM buffer size, SRAM buffer on the control device are reserved to store intermediate data and the control device will accumulate partial VMM results from the PIM device; (3) pipelining between data transmission and computation, i.e. the control device will start operations on partially received vector while the rest are in transmission.

Mapping a model includes storing the weights to the allocated banks, as well as reserving space for the intermediate data (Key, Value matrices) for attention computation since they are dynamically expanded with token generation. To enhance the system performance, the mapping scheme is optimized to: (1) maximize row hit rate by exploiting data locality; (2) increase computational parallelism by balancing the workload across DRAM banks; and (3) reduce latency by minimizing data movement. At runtime, the system computes the bank address in the reserved space to write backKey and Value vectors. The high-level description of the mapping scheme is shown in Algorithm 3 below.

Algorithm 3. ModelMapping to PIMBanks

| Data: Computation Graph; PIM Configuration | |
|---|---|
| Result: Memory Mapping and Reservation | |
| /* Map weights to PIM banks | */ |

| | |
|---|---|
| 1 | for vmmBlock in Computation Graph do |
| 2 | if vmmBlock.multiHead then |
| 3 | I hitScore ← maxRowHit(nhead, ncol) |
| 4 | vmmBlock ← concat(hitScore, vmmBlock) |
| 5 | end |
| 6 | Mapping ← maxParallel(vmmBlock, nch, nbank) |
| 7 | end |

| | |
|---|---|
| /* Reserve PIM bank rows for kv | */ |

| | |
|---|---|
| 8 | for wrBlock in Computation Graph do |
| 9 | if block == write_k then |
| 10 | I hitScore ← maxRowHit(nhead, ncol, Itoken) |
| 11 | wrBlock ← concat(hitScore, wrBlock) |
| 12 | end |
| 13 | Mapping ← Reserve(wrBlock, Itoken, nch, nbank) |
| 14 | end |

The mapping scheme leverages data locality and maximizes computation parallelism. Since activation (ACT) and precharge (PRE) commands are expensive in both latency and energy, achieving a high row hit rate is preferred. To this end, matrix data used for MAC operations need to be mapped to consecutive physical DRAM cells. This approach means the corresponding row only needs to be activated once to transfer all required data to the row buffer, and the MAC units can keep consuming data already in the opened row to minimize ACT and PRE operations.

To take advantage of the data locality, it is desired that a row is fully mapped with data. However, a single attention head can be much smaller than the DRAM array dimension. As shown in FIG. 10, attention headwidth of GPT2-small is 64 while a bank row can store 1024 16-bit data. To maximize the row hit rate, all attention heads in the same layer are concatenated to fill up the DRAM bank. Take GPT2-small as an example, 12 attention heads are concatenated to form a wider matrix with a width of 768, along with the concatenation of input vectors. The data are mapped as an aligned fashion rather than packed, i.e. map the data to the bank row according to matrix row number. This mapping scheme avoids activating two bank rows sequentially to fetch data in the same matrix row. Hence, the latency penalty induced by bank activation can be minimized. To maximize the utilization of MAC units, rows of the matrix are evenly distributed across PIM channels and banks. FIG. 7 also shows a detailed example showing how the Kmatrix is mapped through 8PIMchannels, assuming the token length is 256. First, attention heads in a layer are concatenated along the column direction to form a larger matrix, with a dimension of 256×768. The concatenated matrix is mapped following the row-major approach and evenly distributed as 32 matrix rows to each channel as indicated in the figure. Inside each channel, all 16 banks are mapped with 2 rows of the matrix and execute MAC operations with the same vector in parallel. Given that each bank has 16k rows, the V matrix and FFN weights in the decoder block, along with the matrices from further decoder blocks, can be systematically allocated across the rows of successive banks in the same fashion.

Key and Value results need to be written back to the PIM banks and appended to the existing Key and Value matrices. In the mapping stage, PIM-GPT reserves the required space in PIM banks for these intermediate data. Key and Value write-back are in row-major and column-major, respectively, since the transpose of the Key matrix is required in Equation (1), while not for the Value matrix.

PIM-GPT exploits data locality during writing. During a token generation, a Key vector is produced by multi-attention heads, which corresponds to N=1 in FIG. 10. The Key vectors with a length of 64 from 12 heads are concatenated to form a vector with a length of 768, and written to the corresponding bank row reserved for the current token. The concatenated Key vectors produced by all token generation steps are evenly stored across all channels and banks for parallel downstream VMM computation. Value results are stored in column-major fashion because transpose is not required. To maximize the computation parallelism in the subsequent VMM, one can distribute the Value matrix to all channels and banks using the same mapping scheme for Key matrix mapping as shown in FIG. 10.

For larger GPT models, widths of both concatenated multi-head matrices and weight matrices in the FFN layers can exceed the capacity of a bank row. In this circumstance, the input vector length also exceeds the buffer size. Hence, both the matrix and the vector need to be truncated for VMM operation, as shown in FIG. 6. The partial VMM results are then accumulated in the ASIC to facilitate pipelined operation. Taking the input length of 2048 in FIG. 6 as an example, the matrix and the vector are sliced into two chunks. The elements in the same row will always be mapped to the same bank, as indicated by the faded color. Computation on the second chunk starts after the first chunk is completed to avoid frequently overwriting the SRAM buffer. The weight matrix tiling scheme distributes matrices evenly to achieve the highest possible DRAM channel-wise and bank-wise MAC computation parallelism.

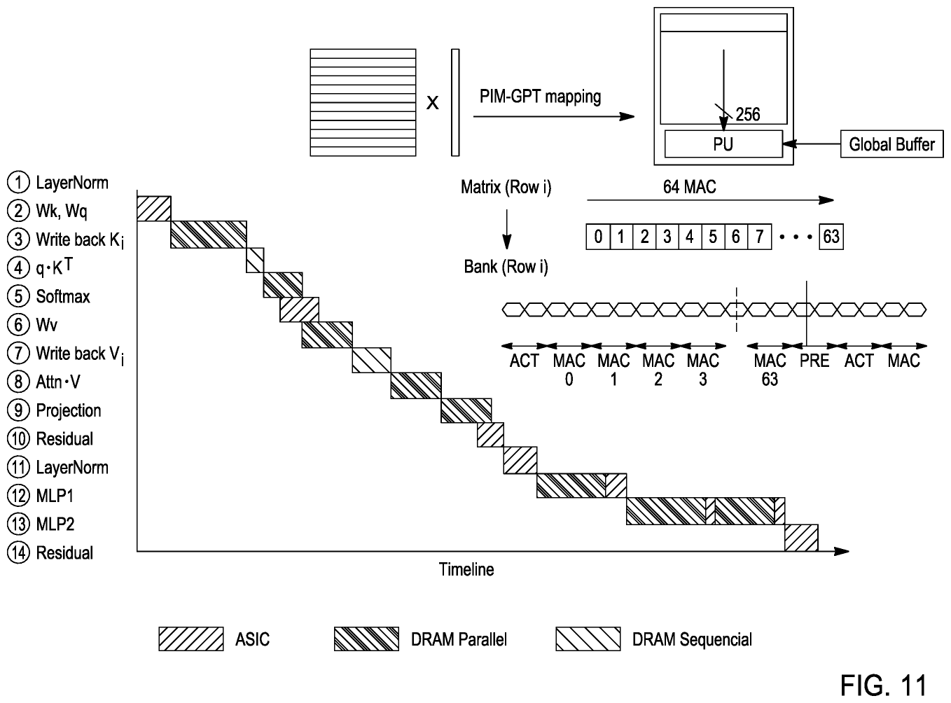

At the system level, latency is minimized by pipelining workload between the memory devices 51 and the control device 52, as well as maximizing DRAM channel-wise and bank-wise parallelism. Although computation blocks in the Transformer-based GPT model rely on sequential executions, it can still be accelerated by forwarding partial results from the DRAM to the ASIC for an early execution. Specifically, for a long output vector, each DRAM channel can only generate 16 output data in a clock cycle due to the limited number of PUs. The partial results can be forwarded to the control device for downstream processing before the whole vector is ready, as shown in softmax (step 5) and residual connection (step 10) in FIG. 11. For VMM input/output projections in the attention and FFN layers, the PIM-GPT mapping scheme distributes weights evenly to all channels to achieve the highest possible DRAM channel-wise and bank-wise parallelism and run as many PUs at the same time as possible.

At the memory level, the aim is to leverage data locality and minimize ACT and PRE commands by following the open row policy in PIM-GPT DRAM bank management. If a row is opened (ACT) for MAC, one wants to maximally use data in that row for the current MAC instruction. As shown in Table I, the tRCD and tRP steps are much longer than tCCD. Increasing the number of ACT and PRE operations will lead to significant energy and latency costs. The timing diagram inset in FIG. 10 shows how taking advantage of the data locality can maximize MAC throughput. If a row in a bank is fully mapped with data in the desired matrix entry, one can perform 64 MAC operations when opening the row only once.

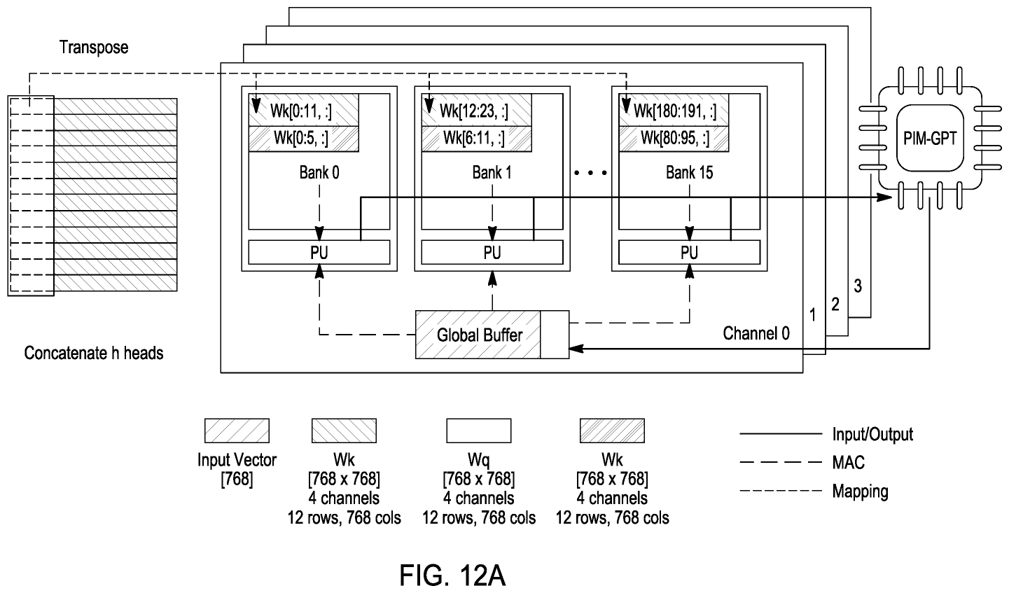

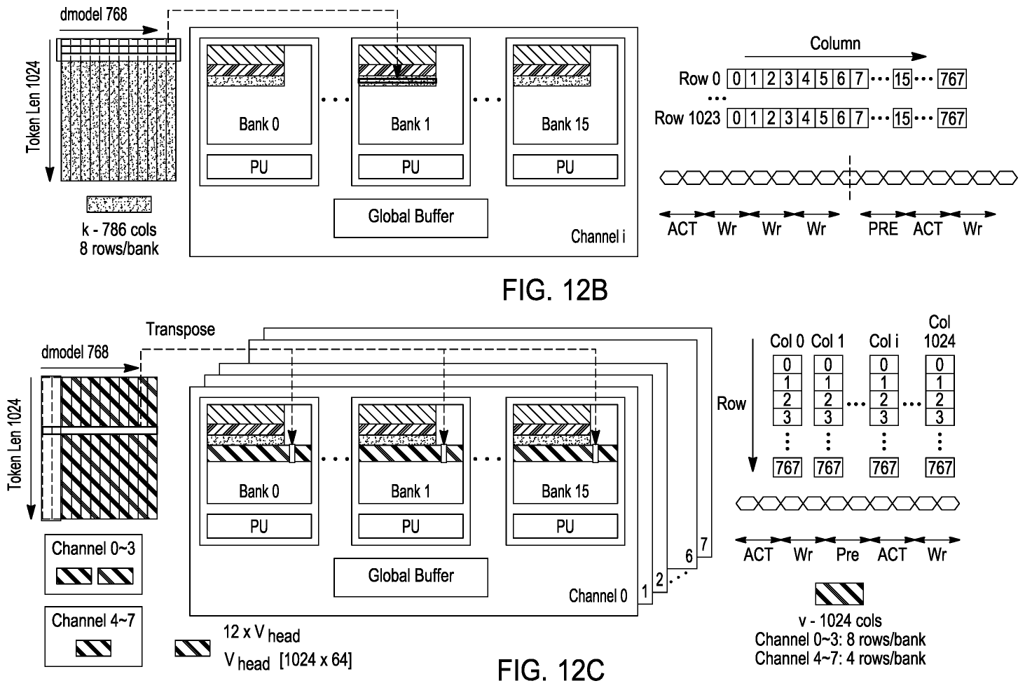

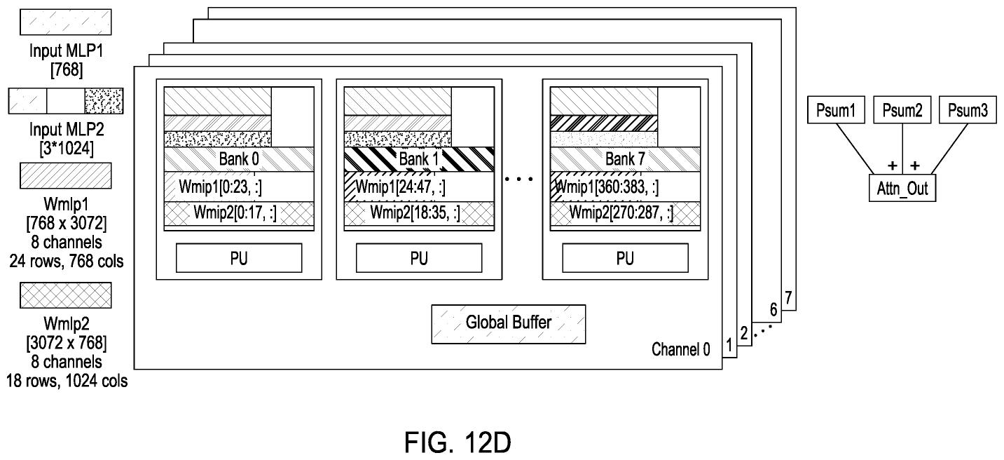

The mapping scheme and dataflow of four main types of computations performed in the memory devices are shown in FIGS. 12A-12D. Key, query and value generations all require vector-matrix multiplication (VMM) with corresponding weight matrices. The obtained key and value vector results are appended to the key and value matrices for the next token. The query remains in the vector format and serves as the input vector in step 4 in FIG. 11. In the proposed accelerator system 50, the PIM device first compute the key and query entries required in the first step of the attention layer (step 4 in FIG. 11). To maximize the DRAM channel level computation parallelism, Wₖ and W_{q} are mapped on the first and the last four channels, respectively. Inside each channel, all weights are evenly distributed among the 16 banks.

FIG. 12A shows Wₖ mapping on DRAM channels 0 to 3. When VMM starts, PIM-GPT will activate all 16 banks in all channels through DRAM commands. The 16 PUs in each channel will work simultaneously to maximize the throughput. When it comes to value computation in step 6 in FIG. 11, it becomes the only VMM execution and can utilize all computation resources. Hence, Wᵥ is mapped across all DRAM channels and banks as shown in FIG. 12A. The input vector will be stored in the GB for VMM operation with Wₖ, W_{q} and Wᵥ matrices.

For VMM results, the query elements computed from the PIM devices will be sent to the control device, assembled and broadcast to the PIM GBs for attention score computation in step 4. Key and value results need to be written back to the DRAM banks on the PIM devices to add to the key and value matrices. DRAM write operations cannot be paralleled, and they will be executed sequentially after adding the corresponding DRAM address to the instruction packet by the control device. The write back scheme of key and value results are shown in FIGS. 12B and 12C, respectively. Key and value write back are in row-major and column-major, respectively, since the transpose of key matrix is required in step 4 in FIG. 11, while no transpose of value matrix is used in step 8.

The key vector results are evenly stored through all DRAM channels in the PIM device. However, for a single token generation, only one key vector will be generated in an attention block, and it will be written to the corresponding DRAM bank row reserved for the current token, as shown in FIG. 12B. PIM-GPT also exploits data locality during write. Since the key vectors from all heads can be concatenated and written into a single row (the statement applied to GPT3-small, but may need to write to multiple rows at larger GPT models), the write command can be executed consecutively after one ACT to write the whole key vector data back to the bank, as shown in the timing diagram in FIG. 12B. With these mapping techniques to utilize data locality, PIM-GPT can achieve a high row hit rate at runtime.

Value result write back is more complex compared to key result due to 1) value results are stored in column-major fashion; and 2) attention heads need to be split when computing the dot product of value matrix and attention score. As shown in the timing diagram of FIG. 12C, one can only activate a row and write one data, followed by moving forward to the next row. Hence, data locality cannot be leveraged in value result write back. The concatenated value results need to be split according to the number of heads, and each head receives a different input vector with size of the current token length. To maximize the computation parallelism in the subsequent step, the optimal scheme is to distribute the value matrix to all banks on the eight channels. However, this scheme cannot be implemented when the number of heads is not a multiple of the number of channels, for example, twelve heads in GPT3-small for eight DRAM channels. In this case, the PIM-GPT mapper will search the distribution to minimize the latency of both step 7 and 8 in FIG. 11. Take GPT3-small as an example, PIM-GPT will map the first eight heads to the first four channels, and the last four heads to the last four channels to maximize the throughput.

Mapping of the attention projection and the two FFN layers is similar to the value matrix computation since they are all linear layers and weights are evenly distributed through all banks on the eight channels. Here the partial sum scheme is explained using the second MLP layer in the GPT3-small model as an example. In PIM-GPT, partial sum is required when the input length exceeds the GB size. Although adding more SRAM buffer to each DRAM bank can solve this issue, larger GB induces a significant area overhead and requires a new design of the PIM chip. Instead, we reserve an SRAM buffer on the control device to store intermediate data. As shown in FIG. 12D, the input length of MLP2 is 3072, which is 3 times of the PIM GB size. PIM-GPT will slice the input data into three pieces. The data are sent to the PIM GB in three steps and the three partial sum results are written back to the ASIC. The ASIC will accumulate all partial results through its large adder array in a pipelined fashion. Once it receives two partial sums, it can start execution while waiting for the following data, as shown in step 13 in FIG. 11. Such a computation scheme increases PIM and ASIC computation parallelism and reduces the required SRAM buffer on ASIC.

To evaluate the PIM-GPT system performance, a simulator is developed to achieve fast and accurate modeling of the system during token generation. For GPT inference, the instruction sequence is deterministic: 1) computation blocks follow a specific sequence and repeat for each Transformer block; 2) the computation block will start only when the previous block finishes the computation.

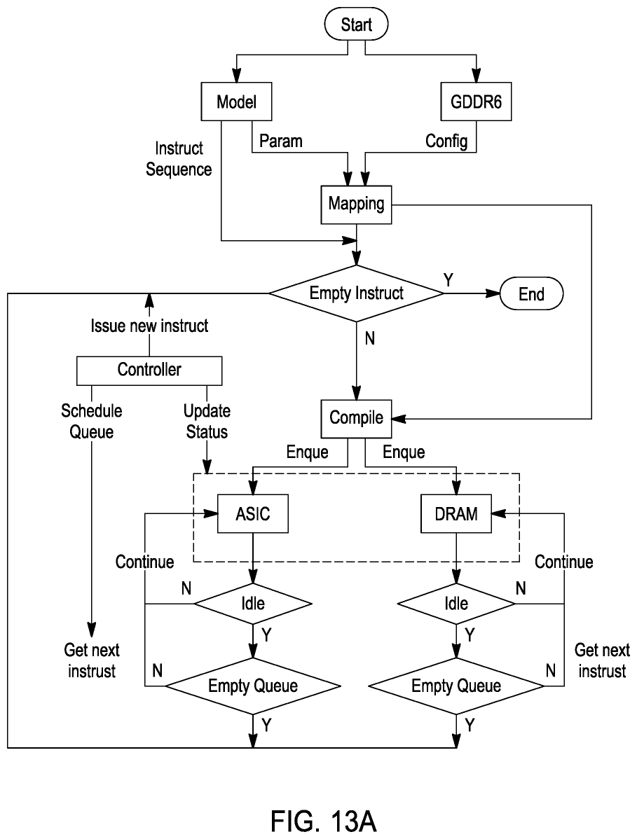

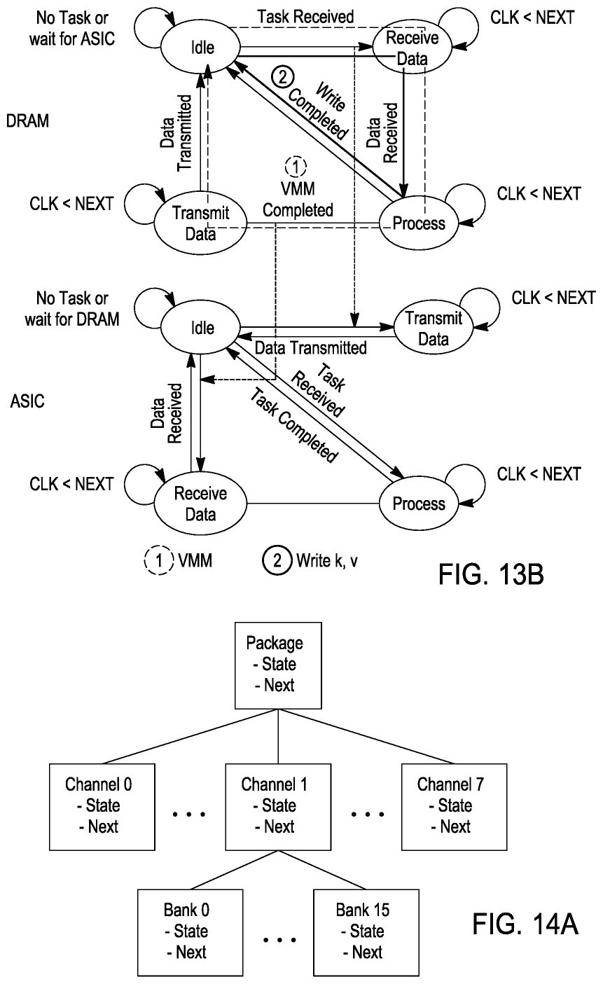

As shown in the flowchart of FIG. 13A, the simulator takes the model and the PIM-GPT configuration as inputs to determine the model mapping, following the scheme described in Algorithm 3 above. The PIM device and the control device behaviors are abstracted as state-machines. The transition of states follows the timing constraints in Table 1. At every clock cycle, the system checks the status of the control device and the PIM device. The next instruction in the specific instruction stream will be fetched only when the current instruction is completely consumed, that is, both the control and the PIM device are in Idle state and no instruction packet is pending in the queue. The new instruction is compiled into a sequence of instruction packets based on the mapping and appended to the queue. The packets contain information of the operation type, input and output data length, and the target DRAM section (not used in the control device packet). The compilation considers the limited hardware resources. For example, when the size of the input vector exceeds the size of the GB, the vector will be sliced into smaller chunks and fed to the memory sequentially. Partial sum operations are then added to the queue.

When the PIM device and the control device are in Idle state, the controller will schedule the instruction packet in the control device and PIM device queues. The PIM instruction packet will be decoded into command sequences at the bank level based on the address information. The PIM device and control device states will be changed accordingly. For this dataflow design, the input data for each sub-computation graph is stored in the control device for downstream arithmetic computation or distributed to the PIM devices. Therefore, a control device instruction will directly put the control device into Process state, whereas a PIM instruction will first position the control device into Send state and the PIM device into Receive state. When the control device and the PIM device complete the current command, they enter the next state defined by the state transition diagram.

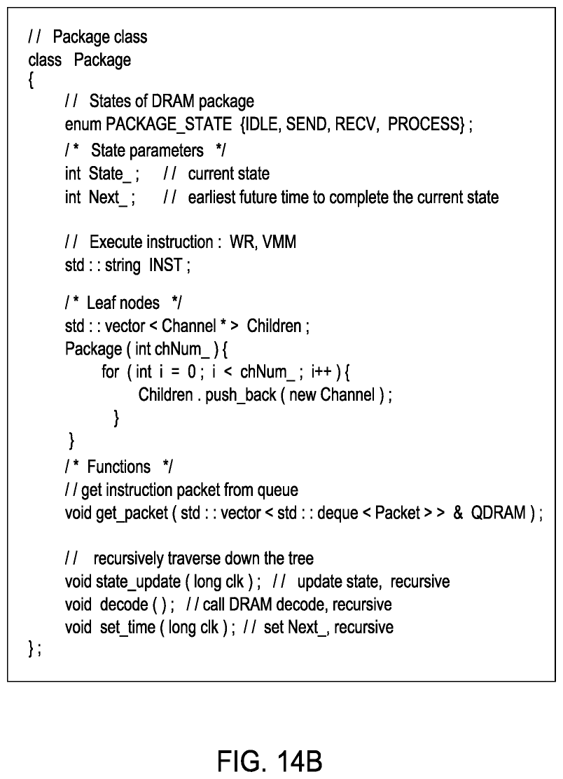

Following the PIM-GPT architecture, the PIM devices are abstracted as a tree of state machines at package, channel, bank levels, as shown in FIG. 14A. The package node refers to the entire DRAM-PIM package that contains 8 channels of DRAM-PIM as child nodes. Each channel contains 16 banks as child nodes. The same organization hierarchy can be found in Ramulator, DRAM simulator that provides performance models for a variety of DRAM standards. Scaling can be evaluated by attaching more channel nodes to a package node. Each node maintains its own States and state-transition sequences. Two sequences are defined for the PIM package node for VMM and write operations, respectively. They both start with Idle→Receive→Process. The VMM results from PIM should be transferred back to the ASIC for arithmetic computation or inter-PIM communication. The state changes from Process→Transmit→Idle. For write, the package node directly switches from Process to Idle.

It should be mentioned that DRAM refresh is not modeled in the simulator for sake of simplicity. To include the effect of refresh on latency and power, assume all PIM channels will stop the processing to perform refresh at the refresh interval. From the simulated latency tₛᵢₘᵤₗₐₜₒᵣ without considering refresh, calculate the expected refresh cycles n_{REFI} by dividing tₛᵢₘᵤₗₐₜₒᵣ with the specified refresh interval t_{REFI}. The additional refresh latency is computed as t_{RFC}*n_{REFI} and added to tₛᵢₘᵤₗₐₜₒᵣ to obtain the final latency reported for PIM-GPT.

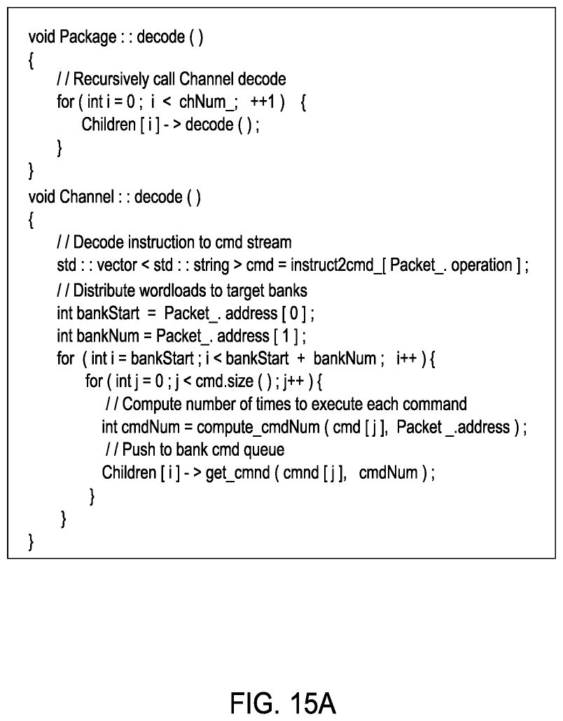

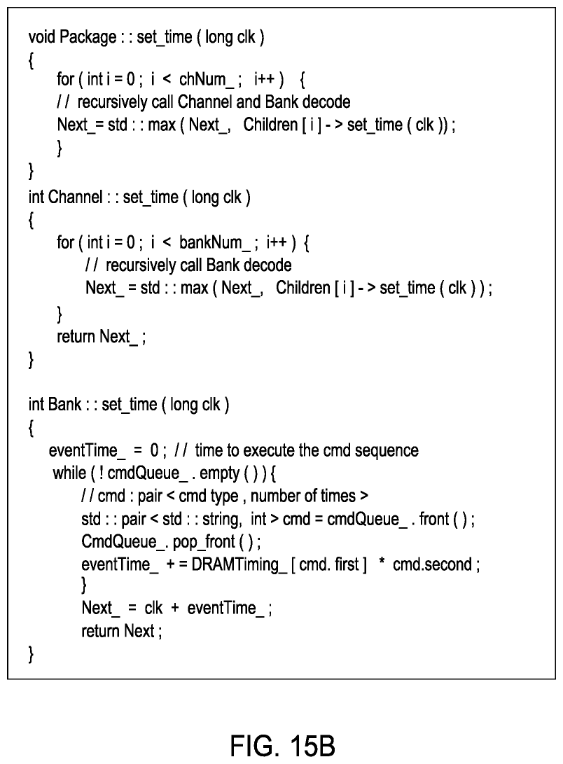

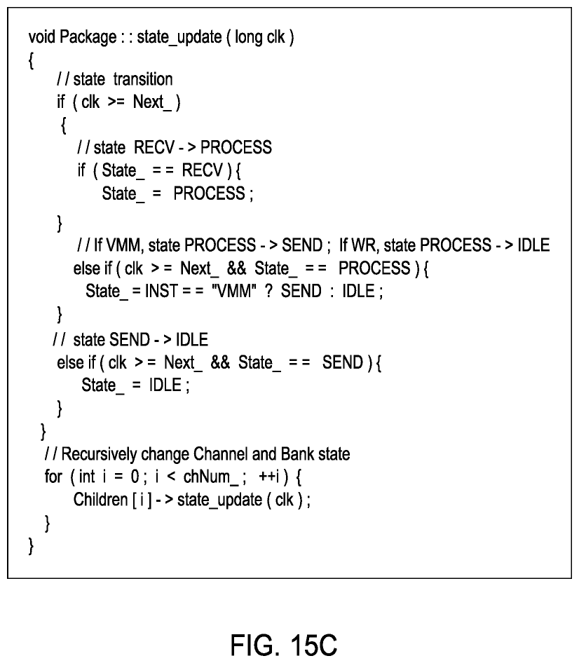

The DRAM packages are specified by states and functions, as shown in FIG. 14B. Apart from the current state, each node also contains a Next parameter, which is the earliest future time the current state can be changed. Three functions, shown in FIGS. 15A-15C, simulate the DRAM state transition when serving a memory request: state_update, decode and set_time. The function at the root (package) node will be traversed down to the child nodes within the instruction. Below we explain how these functions are defined.

decode( ): When the state of the package node transits from Receive to Process, it has obtained the input data from the ASIC and is ready to process the pending memory request. The function walks down to the channel level. Based on the address information of the instruction packet, the channel node will decode the instruction into command streams and the number of times each command needs to be executed. The commands will be appended to the command queue of the target DRAM banks.

set_time( ): After the instruction packet is decoded into command sequences, the simulator computes the future time that the relevant DRAM banks will complete the execution. The function recursively initiates the child nodes to update the Next parameter. The earliest time for the channel node to leave the Process state is when all of its banks finish the workloads. The same logic applies to the package node. The execution time at the bank level is computed based on the timing constraints of GDDR6, as shown in Table 1.

state_update( ): At every cycle, the simulator checks whether the current CLK reaches Next at the package level. If so, the node state will be updated to the next state in the state-transition sequence. If not, the node will remain in its current state. The function also triggers the state update at the Channel level, which will recursively call the state update at the Bank level.

The energy consumption of the proposed accelerator system 50 is the sum of the energy consumptions of the control device and the PIM devices. Power consumption of the computation blocks in the control device is summarized in Table 2. The control device energy consists of three parts: 1) energy consumption in the SRAM buffer; 2) energy consumed by the arithmetic computation block; and 3) energy consumed by the data sending/receiving modules, including data ports and data/request queues. The peak power of the control device in the example proposed accelerator system 50 is 304.59 mW, and is estimated with latency consideration as shown in Equation (9):

$${E}_{ASIC} = {t}_{total} \times {p}_{sram} + {t}_{arith} \times ( {p}_{peak} - {p}_{sram} ) + {t}_{data} \times {p}_{fifo} \qquad ( 9 )$$

TABLE 3
IDD specifications for GPT-PIM.

| IDD | CMD | Current[18] | Description |
|---|---|---|---|
| IDD2N | Idle | 92 mA | Precharge standby current. |
| | | | All banks closed. |
| IDD3N | Idle | 142 mA | Active standby current. |
| | | | All banks open. |
| IDD0 | ACT and | 122 mA | Active current due to ACT |
| | PRE | | and PRE commands. |
| IDD4R | RD | 530 mA | Operating burst read current. |
| IDD4W | WR | 479 mA | Operating burst write current. |
| IDD5B | Refresh | 277 mA | Burst refresh current. |

The PIM device power in the example is evaluated based on the IDD values in the datasheets of Micron's DDR5 technology, as shown in Table 3. It is used to estimate an upper bound of GDDR6 systems energy consumption. IDD2N is the background current when all banks are precharged and closed. IDD3N is the active standby current when all banks are open. Apart from the standby current, a significant amount of current is consumed to decode the command/address and then read out the data from the open DRAM row to the row buffer during ACT command. When the row operation is completed, a PRE command will be issued to charge all bit

$$\frac{1}{2} {V}_{DD} .$$

The active current during the ACT and PRE commands is averaged as IDD0. When a row is ready to serve a request, a sequence of read or write commands is issued. The operating current in burst mode is IDD4R and IDD4 W respectively. For the proposed accelerator system 50, read occurs during the MAC operations, where the data stored in the banks are read to the PUs to perform vector-matrix multiplication with the input vector from the GB. Therefore, the PU power should also be included in MAC mode. Since this value is not reported by SK Hynix, power consumption was evaluated based on our own adder and multiplier design at TSMC 28 nm technology. The power is scaled from 0.9V to 1.25V to match the GDDR6 VDD. As routing is more complex in DRAM due to the limited metal layers, conservatively multiply the power by 1.5 times, which comes to 149.29 mW for 16 PUs. The power is not scaled with respect to the technology node to make the estimate conservative. Since the SK Hynix PIM is fabricated in 1ynm, the actual PU power consumption is expected to be lower than the estimation. To maintain the information stored in the DRAM capacitors, REF command is issued with a maximum interval of tREFI shown in Table 1, and the command requires a duration tRFC to be completed. The current associated with REF operation is IDD5B. It should be noted that during the execution of active operations, a standby current is always consumed (IDD3N). This standby current should be subtracted from IDD0, IDD4 W, IDD4 W, IDD5B to obtain power consumed due to the ACT, WR, MAC and REF commands.

The equations used to calculate the power consumption of one PIM channel are shown below.

$${t}_{closed} = {n}_{PRE} \times {t}_{PRE} + {t}_{Data} + {t}_{arith} \qquad ( 10 )$$

$${t}_{open} = {t}_{total} - {t}_{closed} \qquad ( 11 )$$

$${E}_{closed} = {t}_{closed} \times IDD 2 N \times {V}_{DD} \qquad ( 12 )$$

$${E}_{open} = {t}_{open} \times IDD 3 N \times {V}_{DD} \qquad ( 13 )$$

$${E}_{ACT \& PRE} = ( {t}_{open} - {n}_{PRE} \times {t}_{RP} ) \times ( IDD 0 - IDD 3 N ) \times {V}_{DD} + {n}_{PRE} \times {t}_{RP} \times ( IDD 0 - IDD 2 N ) \times {V}_{DD} \qquad ( 14 )$$

$${E}_{WR} = {n}_{WR} \times {t}_{CCD} \times ( IDD 4 W - IDD 3 N ) \times {V}_{DD} \qquad ( 15 )$$

$${E}_{MAC} = {n}_{MAC} \times {t}_{CCD} \times ( ( IDD 4 R - IDD 3 N ) \times {V}_{DD} + {P}_{PU} ) \qquad ( 16 )$$

$${E}_{REF} = {n}_{REF} \times {t}_{RFC} \times ( IDD 5 B - IDD 3 N ) \times {V}_{DD} \qquad ( 17 )$$

$${E}_{channel} = {E}_{closed} + {E}_{open} + {E}_{ACT \& PRE} + {E}_{WR} + {E}_{MAC} + {E}_{REF} \qquad ( 18 )$$

The total energy consumption of the PIM-GPT system is the sum of the energy consumption of all PIM channels and the control device, and is used in the benchmark analysis below.

The performance and energy efficiency of the proposed accelerator system 50 are evaluated using the simulator and compared to GPU (NVIDIA T4) and CPU (Intel Xeon Gold 6154). The core attention blocks of 8 GPT models shown in Table 4, excluding the input embedding layer, are implemented in the proposed accelerator system 50 and used for the benchmark analysis.

TABLE 4
Sizes, architectures and floating
points operations of 8 GPT models.

| | | | | | Params | FLOPs |
|---|---|---|---|---|---|---|
| Model Name | n_{layer} | d_{model} | n_{heads} | d_{head} | (M)* | (M)* |
| GPT2-small | 12 | 768 | 12 | 64 | 81 | 180 |
| GPT2-medium | 24 | 1024 | 16 | 64 | 288 | 624 |
| GPT2-large | 36 | 1280 | 20 | 64 | 675 | 1440 |
| GPT2-XL | 48 | 1600 | 25 | 64 | 1406 | 2963 |
| GPT3-small | 12 | 768 | 12 | 64 | 81 | 180 |
| GPT3-medium | 24 | 1024 | 16 | 64 | 288 | 624 |
| GPT3-large | 24 | 1536 | 16 | 96 | 648 | 1368 |
| GPT3-XL | 24 | 2048 | 16 | 128 | 1152 | 2400 |

*The input embedding layer is not included in the number of parameters and FLOPs.

NVIDIA T4 uses GDDR6 as memory technology. The attention blocks of HuggingFace GPT models are run in Pytorch. Latency is recorded using torch.cuda.Event( ), and power is measured with pynvml, which is a wrapper around the NVIDIA management library. The dynamic power during GPT inference is tracked at each token and multiplied with the corresponding latency to get the total power. For CPU characterization, one can use python package time.time( ) for latency measurement and an open-source terminal tool s-tui for power monitor. Similar to the GPU case, one can use the dynamic power times latency to get the energy consumption for the workload. Each test includes 10 trials of 1024 token generations, and the average of the energy and latency values from the 10 tries are reported.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An accelerator architecture for a Transformer machine learning model, comprising:
one or more memory devices, each memory device has a random access memory and is configured for processing in memory, where a key matrix, a value matrix, a query weight matrix, a key weight matrix, and a value weight matrix for an attention mechanism of the Transformer machine learning model are stored in the one or more memory devices; and
a control device interfaced with each of the one or more memory devices, the control device is configured to receive an input vector and coordinates a first vector-matrix multiplication of the input vector with the query weight matrix, such that the first vector-matrix multiplication operation is performed on the one or more memory devices and an output of the first vector-matrix multiplication operation is used by the control device for subsequent processing;
the control device coordinates a second vector-matrix multiplication operation between the input vector and the key weight matrix, such that the second vector-matrix multiplication operation is performed on the one or more memory devices and an output of the second vector-matrix multiplication operation is used by the control device for subsequent processing;
the control device coordinates a third vector-matrix multiplication operation between the input vector and the value weight matrix, such that the third vector-matrix multiplication operation is performed on the one or more memory devices and an output of the third vector-matrix multiplication operation is used by the control device for subsequent processing.

2. The accelerator of claim 1 wherein the control device is configured to perform layer normalization, a softmax function, and an activation function.

3. The accelerator of claim 1 wherein portions of the key matrix are stored across the one of more memory devices and the control device coordinates vector-matrix multiplication of the input vector on applicable memory devices.

4. The accelerator architecture of claim 1 wherein the control device adds the output from the second vector-matrix multiplication operation to the key matrix stored across the one of more memory devices.

5. The accelerator architecture of claim 4 wherein the control device coordinates a fourth vector-matrix multiplication operation of the output vector from the first vector-matrix multiplication operation and the updated key value matrix, such that the fourth vector-matrix multiplication operation is performed on the one or more memory devices and an output of the fourth vector-matrix multiplication operation is used by the control device for subsequent processing.

6. The accelerator of claim 5 wherein the control device performs a softmax function on the output of the fourth vector-matrix multiplication operation.

7. The accelerator architecture of claim 6 wherein the control device adds the output from the third vector-matrix multiplication operation to the value matrix.

8. The accelerator of claim 7 wherein the control device coordinates a fifth vector-matrix multiplication of output from the softmax function with the updated value matrix, such that the fifth vector-matrix multiplication operation is performed on the one or more memory devices and an output of the fifth vector-matrix multiplication operation is passed back to the control device for subsequent processing.

9. The accelerator of claim 8 wherein the control device performs layer normalization on the output of the fifth vector-matrix multiplication operation.

10. The accelerator of claim 1 wherein the control device includes a data queue, a request queue, an instruction queue, a buffer, a packetizer, a crossbar interconnect, a memory bus, and arithmetic compute engines.

11. The accelerator of claim 1 wherein the control device interfaces with each of the one or more memory devices through a crossbar interconnect and a memory bus.

12. The accelerator of claim 1 further comprises a compiler that maps weights, intermediate outputs and operations of the Transformer model.

13. The accelerator of claim 1 wherein the control device executes the operations of the Transformer model in a dataflow manner.

14. The accelerator of claim 1 further comprises a scheduler interfaced with the control device and the one or more memory devices, where the scheduler operates as a state machine for the operation of a command stream.

15. The accelerator of claim 14 further comprises a register, where the scheduler loads the command stream into the register for use by the accelerator.

16. The accelerator of claim 1 wherein partial results of vector-matrix multiplication are transmitted from the one or more memory devices to the control device before the vector-matrix multiplication operation is complete.

17. The accelerator of claim 16 wherein the control device accumulates the partial results from the one or more memory device in a buffer.

18. The accelerator of claim 16 wherein the control device begins operation on the partial results of the vector-matrix multiplication before an entire result of the vector-matrix multiplication is transmitted to the control device by the one or more memory devices.

19. The accelerator of claim 1 wherein a given attention head is partitioned across a series on memory devices and stored in parallel at same address of the random access memory in the series on memory devices.
